(19) United States
(12) Patent Application Publication
(10) Pub. No.: US 2002/0158531 A1
(43) Pub. Date: Oct. 31, 2002

(54) Device for kinetic energy accelerator/amplifier

(76) Inventor: Satoru Aritaka, Chiba (JP)

Correspondence Address: STEVENS, DAVIS, MILLER & MOSHER, LLP, 1615 L Street N.W., Suite 850, Washington, DC, 20036, US

(21) Appl. No.: 09/881,207

(22) Filed: Jun. 15, 2001

(30) Foreign Application Priority Data
Apr. 27, 2001 (JP) 2001-130691

(51) Int. Cl. H02K 21/00

(52) U.S. Cl. 310/152

(57) ABSTRACT

A device to accelerate and amplify rotary motion energy utilizing magnetic force, which creates a larger amount of kinetic energy than the energy consumed. A driven rotor with a plurality of permanent magnets attached on its external circumference is rotatably mounted, and a drive rotor with a plurality of permanent magnets on its external circumference is provided close to the driven rotor, with the permanent magnets provided at the drive rotor being more than 1 time as many in number as those provided at the driven rotor, and each pair of these adjacent permanent magnets having an inverse polarity to each other, each permanent magnet on the driven rotor being adjusted to be located between each pair of adjacent permanent magnets on the drive rotor. When the drive rotor is rotated, one of the pair of its permanent magnets on the drive rotor attracts one permanent magnet on the driven rotor located between them while the other pushes it away by its repulsive force, thereby accelerating and amplifying the rotation of the driven rotor.

### TECHNICAL FIELD

This invention is related to a device for accelerating and amplifying rotary or straight-line motion energy by its rotary motion using magnetic force.

### BACKGROUND

Conventionally, various kinds of mechanisms of perpetual motion utilizing magnet have been devised but none of them could be put into practical use with success. Motors and generators have the output efficiency of 30% ˜90% in most cases, not exceeding the level of 100%. It has been a generally accepted idea shared by all people that the output efficiency beyond 100% is impossible as proved by the principle of the conservation of energy.

It has been our sincere long hope to improve the output efficiency of motors, etc. utilizing magnet. On the other hand, creating a new large energy source without wasting many resources to meet the world energy consumption that is recently increasing year by year has been our long-cherished desire, which still remains to be realized.

### SUMMARY OF THE INVENTION

The inventor thought how to create a new large energy source without consuming resources or energy as far as possible, and as a result, reached the idea of creating larger energy by amplifying it by means of magnetic force that exists everywhere in unlimited volume. More specifically, this invention provides a kinetic energy accelerator/amplifier that rotates a motor by means of only a small amount of electric energy (i.e., saving resources as far as possible), accelerates and amplifies its revolution force utilizing the attractive and repulsive forces from the north and south poles of a magnet, thus creating more kinetic energy than the energy consumed.

This invention provides a device for kinetic energy accelerator/amplifier characterized by that a driven rotor with a plurality of permanent magnets provided at a fixed interval on its external circumference is rotatably mounted, and one or more drive rotors each with a plurality of permanent magnets provided at a fixed interval on their external circumference are installed close to the external circumference of the driven rotor,

the permanent magnets on the one or more plural drive rotors being more than 1 time as many as those on the driven rotor,

each pair of adjacent permanent magnets in those arranged on the external circumference of the one or more drive rotors having an inverse polarity to each other, and

the permanent magnets on the driven motor and drive rotors being adjusted so that each permanent magnet on the driven rotor may be positioned between each two adjacent permanent magnets on each of the one or more drive rotors having an inverse polarity to each other, and

when the drive rotor are rotated, one of the pair of adjacent permanent magnets on each of the drive rotors having an inverse polarity to each other attracts a permanent magnet on the driven rotor located between them while the other of the pair pushes it by its repulsive force, thereby accelerating and amplifying the rotation of the driven rotor.

A device for kinetic energy accelerator/amplifier characterized by that a driven rotor with a plurality of permanent magnets provided at a fixed interval on its external circumference is rotatably mounted, and one or more drive rotors each with a plurality of permanent magnets provided at a fixed interval on their external circumference are installed close to the external circumference of the driven rotor,

the permanent magnets on the one or more plural drive rotors being less than 1 time as many as those on the driven rotor,

each pair of adjacent permanent magnets in those arranged on the external circumference of the one or more drive rotors having an inverse polarity to each other, and

the permanent magnets on the driven motor and drive rotors being adjusted so that each permanent magnet on the driven rotor may be positioned between each two adjacent permanent magnets on each of the one or more drive rotors having an inverse polarity to each other, and

when the drive rotor are rotated, one of the pair of adjacent permanent magnets on each of the drive rotors having an inverse polarity to each other attracts a permanent magnet on the driven rotor located between them while the other of the pair pushes it by its repulsive force, thereby accelerating and amplifying the rotation of the driven rotor.

Thus, rotation force can be transmitted to the driven rotor by rotating the drive rotor, and the rotation of the driven rotor can be accelerated and amplified utilizing the magnets' attraction and repulsion force, thus leading to creating more energy output than the energy input. This drive system is suitable to driving a generator and vehicles like automobiles, etc.

### BRIEF EXPLANATION OF THE DRAWINGS

FIG. 1 shows a plan for illustrating the principle of the drive system according to this invention,

FIG. 2 shows a plan for explaining the first embodiment of this invention, and

FIG. 3 shows a perspective view to explain the second embodiment of this invention.

### DETAILED OF THE PREFERRED EMBODIMENTS

This invention will hereinafter be explained in detail in reference to the accompanying drawings.

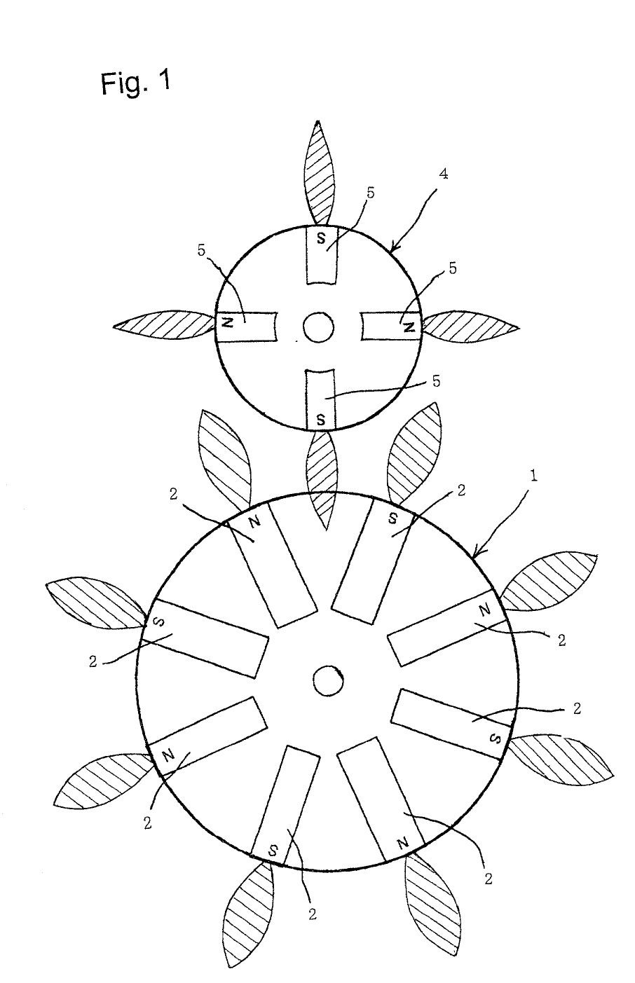

According to this invention, as shown in FIG. 1, each pair of adjacent magnets 2 in a series of the magnets 2 arranged with an interval on the external circumference of the drive rotor 1 have an inverse polarity to each other, and each permanent magnet 5 on the driven rotor 4 is located at a central position between two adjacent magnets 2 and 2′ with opposite polarity to each other on the drive rotor 4. If the drive rotor 1 is rotated anticlockwise, one of the two opposite-polarity magnets 2 (N pole) on the rotor 1 attracts one of the permanent magnets 5 (S pole) on the driven rotor 4, while the other magnet 2′ (S pole) pushes the one of the permanent magnets 5 (S pole) by its repulsive force, thus rotating the drive rotor 4 clockwise. In this way, magnetic flux of each permanent magnet 5 on the driven rotor 4 enters between the magnetic flux of a pair of adjacent magnets 2 on the external circumference of the drive rotor 1, and as these drive and driven rotors rotate, the magnetic flux of permanent magnets 2 on the external circumference of the drive rotor 1 engages with the magnetic flux of permanent magnets 5 of the driven rotor 4 to rotate the driven rotor 4. The rotation of driven rotor 4 is increased and amplified in proportion to the ratio of permanent magnets 5 on the drive rotor 4 to those on the driven rotor 1 in terms of their number. Further, all the permanent magnets 2 and 5 on the external circumferences of the drive and driven rotors 1 and 5 are magnetized in the direction from their circumferences to their centers. The magnetic flux of each magnet is shown by its hatching in FIG. 1. The rotation of the driven rotor 4 obtained in this system can be used as rotating force as they are or used as straight-line motion after converted from the rotating force.

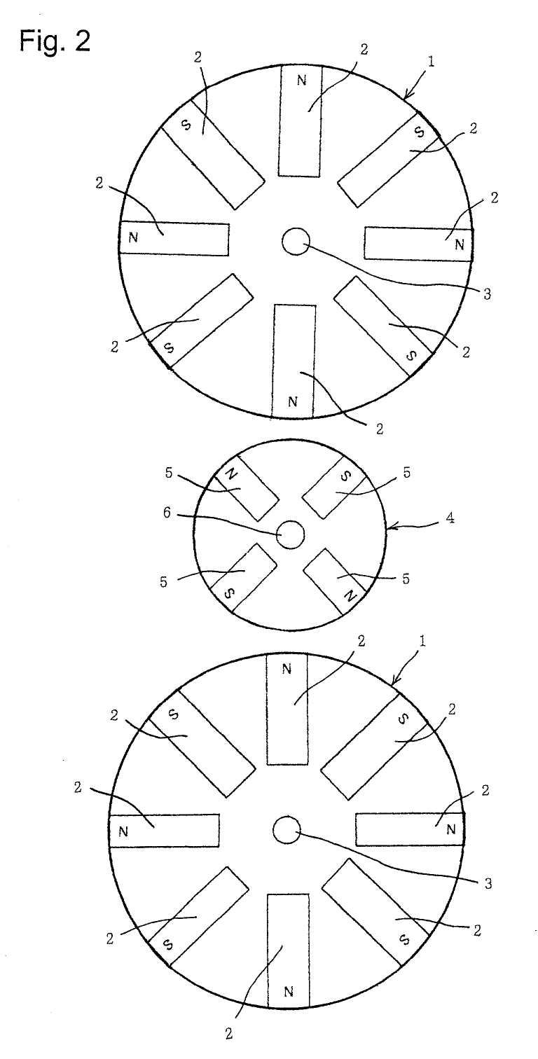

FIG. 2 shows the first embodiment of this invention, which has two drive rotors 1 installed at two opposite positions immediately above and below a driven rotor 4. A driven rotor 4 having four permanent magnets 5 installed at an equal interval on its external circumference is rotatably mounted around a central shaft 6 made in one with the driven rotor 4. The permanent magnets 5 arranged on its external circumference are inversed in polarity to their respective left and right adjacent magnets. Therefore, these permanent magnets 5 have their N and S poles alternately positioned outward at an interval of 900 along the external circumference of the driven rotor 4.

And, drive rotors 1, 1 each two-times larger in diameter than this driven rotor 4 are provided at two opposite positions outside and close to the external circumference of the driven rotor 4. Each drive rotor 1 is rotatable around the center shaft 3 build in one with the drive rotor 1. Its external circumference has eight permanent magnets 2 installed at an equal interval, and any adjacent pair of these magnets 2 has an inverse polarity to each other. Therefore, these permanent magnets 2 are arranged, with their N and S poles alternately positioned outward at an interval of 45° along the external circumference of each drive rotor 1. Also, the space between the external circumferences of driven and drive rotors 4 and 1 will be determined so that the attractive and repulsive force of magnets may have the maximum effect of rotating the driven rotor. Also, the material of the drive and driven rotors 1 and 4 is a non-magnetic material, which is grooved at a specified position to bury the permanent magnet 2 or 5. Further, each of these drive and driven rotors 1 and 4 is usually several cm thick, but an appropriate different thickness may be used at need.

One permanent magnet 5 on the driven rotor 4 may be positioned at the center between each pair of adjacent magnets 2, 2 on the drive rotor 1 with an inverse polarity to each other, making such a system that if the rotor 1 is driven and rotated with an appropriate means like a motor, one of the pair of permanent magnets 2, 2 with an inverse polarity to each other on the drive rotor 1 attracts one permanent magnet 5 while the other pushes it by its repulsive force, thereby rotating the driven rotor 4 around the central shaft 6. Operation of the drive rotor 1 accelerates the operation of the driven rotor 4, i.e., every time when former makes a turn, the latter makes two turns. Further the driven rotor 4 can have an increased torque by receiving rotary force from two drive rotors 1, 1 located at its both sides.

In this embodiment, the ratio of the number of permanent magnets 5 in the driven rotor 4 to that in the drive rotor 1 is 1:2, which has doubled the rotational frequency of the driven rotor 4. This application is only one example; if the ratio of 1:3 is used between the numbers of magnets in the drive and driven rotors, the driven rotor 4 would be triplicated in its revolutions, and if the ratio is 1:4, the revolutions would be quadrupled. The driven rotor 4 will vary in its revolutions according to the ratio of a magnet number to another in these two kinds of rotors 4 and 1.

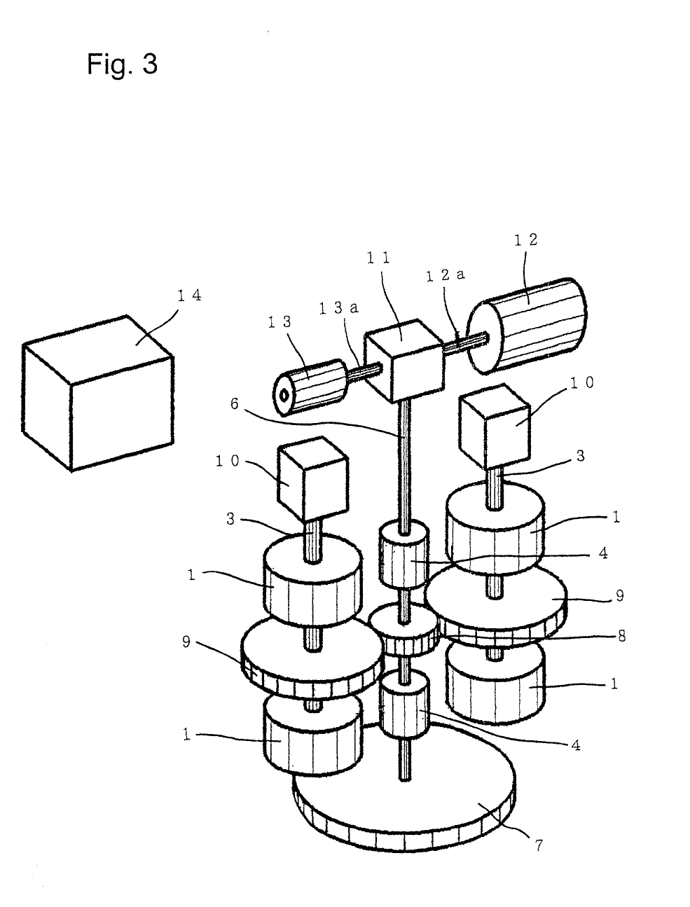

FIG. 3 explains the second embodiment of this invention wherein a device for the kinetic energy accelerator/amplifier according to this invention is applied to a generator.

A center shaft 6 has a flywheel 7 attached to its bottom and a center gear 8 at its middle part of the center shaft 6 and driven rotors 4, 4 are installed above and below this center gear 8 on the same center shaft 6. This center shaft 6 is rotatably supported. Near this shaft 6, two other central shafts 3, 3 are arranged, and a peripheral gear 9 engaged with the center gear 8 on the central shaft 6 is fixed to each of these central shafts 3, 3. Each of these peripheral gears 9 has a gear ratio of 2:1 to the center 8, and is two times greater in diameter than the latter, which rotates two times every time when the peripheral gear 9 makes a turn.

Further, each of these peripheral gears 9 on the central shafts 3 has a pair of drive rotors 1 above and below it, and each external circumference of these drive rotors 1 is located close to each external circumference of the respective driven rotors 4 on the center shaft 6. No explanation will be made about the relationship between these drive rotors 1 and driven rotors 4 as it is the same as in the first embodiment and has already been mentioned before. Further, a servomotor 10 is attached to one end of each central shaft 3.

The center shaft 6 is provided at its top with a T-shaped gear 11, of which one end is connected with an output generator 12 through its horizontal rotary shaft 12a, and the other end with a drive generator 13 through its horizontal rotary shaft 13a. Power obtained by the drive generator 13 is stored in a drive battery 14.

In the system according to this second embodiment, when each servomotor 10 is operated, each central shaft 3 supporting the servomotor commences rotation. Then, as in the case of the first embodiment (see FIG. 2), the driven rotor 4 starts to rotate as each permanent magnet 5 (e.g., S pole) on its external circumference that is located between a pair of permanent magnets 2 on the external circumference of the drive rotor 1 having an inverse polarity to each other is attracted by one magnet of the pair (e.g., N pole) while it is pushed away by the other of the pair (e.g., S pole) by its repulsive force. Since the peripheral gears 9 on the central shafts 3 are engaged and rotated together with the center gear 8 on the center shaft 6, this ensures the transmission of revolution force of drive rotors 1 to the driven rotor 4.

One driven rotor 4 is rotated by two drive rotors 1, this drive system consists of two vertical subsystems, and the attractive and repulsive force of these drive rotors 1 are concentrated on the center shaft 6 or the driven rotors 4 thereon to accelerate and amplify their rotation, so the rotation of the center shaft 6 can further increase. Part of this rotary force drives the drive generator 13 via the T-shaped gear 11 to generate power. The power generated by it is stored in the drive battery 14, or drives the servomotors 10 to continue power generation. The generated power can also be used in part to drive the output generator 12 for generating large power.

Incidentally, it should be noted that once they start rotation, the motor and generator need to consume no large power to maintain their operation. This is enhanced in this second embodiment, since a flywheel provided at the bottom of center shaft 6 will play the role of further reducing the power consumption by the servomotors 10 to the minimum. Further acceleration and amplification of the rotary force of the center shaft 6 sometimes promotes the servomotors 10 to have electromagnetic action leading to power generation and the generated power is stored in the drive battery 14, which makes the power consumption by servomotors 10 extremely small or just zero. In other words, it is possible to generate a large amount of power using an extremely small amount of electric energy.

In the above embodiment, two drive rotors 1, 1 are provided for one driven rotor 4, but either one or more than two drive rotors 1 may be used to rotate one driven rotor 4. Also, the revolutions of driven rotor 4 can be accelerated and amplified by increasing the permanent magnets 2 on the drive rotor 1 in number so that they are equal to or more than those 5 on the driven rotor 4, but the torque of driven rotor 4 can be amplified instead of its rotational speed being accelerated by reducing the permanent magnets 2 on the drive rotor 1 in number so that they are less than those 5 on the driven rotor 4. In this embodiment, further, a central gear and peripheral gears to engage with it are provided to ensure the transmission of rotary force, but this is not an essential requirement for this invention.

### Industrial Applicability

The foregoing embodiments of this invention make it possible that by rotating a drive rotor, its rotary force are transmitted to a driven rotor, and also that the rotation of the driven rotor is accelerated and amplified by means of the attractive and repulsive force of magnets provided on the external circumferences of these drive and driven rotors, thereby creating more output energy than the energy input. Therefore this invention is suitable for the driving operation of a generator, driving of automobiles, etc.

1. A device for kinetic energy accelerator/amplifier characterized by that a driven rotor with a plurality of permanent magnets provided at a fixed interval on its external circumference is rotatably mounted, and a drive rotor with a plurality of permanent magnets provided at a fixed interval on its external circumference is installed close to the external circumference of said driven rotor,
the permanent magnets on said drive rotor being more than 1 time as many as those on said driven rotor,
each pair of adjacent permanent magnets in those arranged on the external circumference of said drive rotor having an inverse polarity to each other, and
one permanent magnet on said driven rotor being positioned between two adjacent permanent magnets on said drive rotor having an inverse polarity to each other, and
when said drive rotor is rotated, one of said pair of adjacent permanent magnets thereon having an inverse polarity to each other attracts a permanent magnet on said driven rotor located between them while the other of said pair pushes it by its repulsive force, thereby accelerating and amplifying the rotation of said driven rotor.

2. A device for kinetic energy accelerator/amplifier characterized by that a driven rotor with a plurality of permanent magnets provided at a fixed interval on its external circumference is rotatably mounted, and a drive rotor with a plurality of permanent magnets provided at a fixed interval on its external circumference is installed close to the external circumference of said driven rotor,
the permanent magnets on said drive rotor being less than 1 time as many as those on said driven rotor,
each pair of adjacent permanent magnets in those arranged on the external circumference of said drive rotor having an inverse polarity to each other, and
one permanent magnet on said driven rotor being positioned between two adjacent permanent magnets on said drive rotor having an inverse polarity to each other, and
when said drive rotor is rotated, one of said pair of adjacent permanent magnets thereon having an inverse polarity to each other attracts a permanent magnet on said driven rotor located between them while the other of said pair pushes it by its repulsive force, thereby accelerating and amplifying the rotation of said driven rotor.

3. A device for kinetic energy accelerator/amplifier characterized by that a driven rotor with a plurality of permanent magnets provided at a fixed interval on its external circumference is rotatably mounted, and a plurality of drive rotors each with a plurality of permanent magnets provided at a fixed interval on their external circumferences are installed close to the external circumference of said driven rotor,
the permanent magnets on each of said plural drive rotors being more than 1 time as many as those on said driven rotor,
each pair of adjacent permanent magnets in those arranged on the external circumference of each of said drive rotors having an inverse polarity to each other, and
said permanent magnets on said driven motor and drive rotors being adjusted so that each permanent magnet on said driven rotor may be positioned between each two adjacent permanent magnets on each of said drive rotors having an inverse polarity to each other, and
when said drive rotors are rotated, one of said pair of adjacent permanent magnets on each of said drive rotors having an inverse polarity to each other attracts a permanent magnet on said driven rotor located between them while the other of said pair pushes it by its repulsive force, thereby accelerating and amplifying the rotation of said driven rotor.

4. A device for kinetic energy accelerator/amplifier characterized by that a driven rotor with a plurality of permanent magnets provided at a fixed interval on its external circumference is rotatably mounted, and a plurality of drive rotors each with a plurality of permanent magnets provided at a fixed interval on their external circumferences are installed close to the external circumference of said driven rotor,
the permanent magnets on each of said plural drive rotors being less than 1 time as many as those on said driven rotor,
each pair of adjacent permanent magnets in those arranged on the external circumference of each of said drive rotors having an inverse polarity to each other, and
said permanent magnets on said driven motor and drive rotors being adjusted so that each permanent magnet on said driven rotor may be positioned between each two adjacent permanent magnets on each of said drive rotors having an inverse polarity to each other, and
when said drive rotors are rotated, one of said pair of adjacent permanent magnets on each of said drive rotors having an inverse polarity to each other attracts a permanent magnet on said driven rotor located between them while the other of said pair pushes it by its repulsive force, thereby accelerating and amplifying the rotation of said driven rotor.

5. A device for kinetic energy accelerator/amplifier characterized by that a driven rotor with a plurality of permanent magnets provided at a fixed interval on its external circumference is rotatably mounted, and one or more drive rotors each with a plurality of permanent magnets provided at a fixed interval on their external circumference are installed close to the external circumference of said driven rotor,
the permanent magnets on said one or more plural drive rotors being more than 1 time as many as those on said driven rotor,
each pair of adjacent permanent magnets in those arranged on the external circumference of said one or more drive rotors having an inverse polarity to each other, and
said permanent magnets on said driven motor and drive rotors being adjusted so that each permanent magnet on said driven rotor may be positioned between each two adjacent permanent magnets on each of said one or more drive rotors having an inverse polarity to each other,
gears being provided at the center shaft of said driven rotor and the central shafts of said drive rotors to connect them through mutual engagement of these gears, and
when said drive rotor are rotated, one of said pair of adjacent permanent magnets on each of said drive rotors having an inverse polarity to each other attracts a permanent magnet on said driven rotor located between them while the other of said pair pushes it by its repulsive force to make the gear of central shaft of each drive rotor rotate the gear of center shaft of driven rotor, thereby accelerating and amplifying the rotation of said driven rotor.

6. A device for kinetic energy accelerator/amplifier characterized by that a driven rotor with a plurality of permanent magnets provided at a fixed interval on its external circumference is rotatably mounted, and one or more drive rotors each with a plurality of permanent magnets provided at a fixed interval on their external circumference are installed close to the external circumference of said driven rotor,
the permanent magnets on said one or more plural drive rotors being less than 1 time as many as those on said driven rotor,
each pair of adjacent permanent magnets in those arranged on the external circumference of said one or more drive rotors having an inverse polarity to each other, and
said permanent magnets on said driven motor and drive rotors being adjusted so that each permanent magnet on said driven rotor may be positioned between each two adjacent permanent magnets on each of said one or more drive rotors having an inverse polarity to each other,
gears being provided at the center shaft of said driven rotor and the central shafts of said drive rotors to connect them through mutual engagement of these gears, and
when said drive rotor are rotated, one of said pair of adjacent permanent magnets on each of said drive rotors having an inverse polarity to each other attracts a permanent magnet on said driven rotor located between them while the other of said pair pushes it by its repulsive force to make the gear of central shaft of each drive rotor rotate the gear of center shaft of driven rotor, thereby accelerating and amplifying the rotation of said driven rotor.
